(19) United States
(12) Patent Application Publication
(10) Pub. No.: US 2009/0313202 A1
(43) Pub. Date: Dec. 17, 2009

(54) SYSTEMS AND METHODS FOR AUTOMATED SEARCH-BASED PROBLEM DETERMINATION AND RESOLUTION FOR COMPLEX SYSTEMS

(76) Inventors: Genady Grabarnik, Scarsdale, NY (US); Sidney Lawrence Hantler, Cortlandt Manor, NY (US); Shwartz Larisa, Scarsdale, NY (US); William Louis Luken, Yorktown Heights, NY (US)

Correspondence Address: TUTUNJIAN & BITETTO, P.C., 20 CROSSWAYS PARK NORTH, SUITE 210, WOODBURY, NY, 11797, US

(21) Appl. No.: 12/138,991

(22) Filed: Jun. 13, 2008

(51) Int. Cl. G06N 5/02

(52) U.S. Cl. 706/50

(57) ABSTRACT

Systems and methods are provided to implement automated search-based problem determination and resolution systems in which a domain-specific data model for a class of complex systems, which is representative of structural relationships of entities within the class of complex systems, is utilized to provide enhanced domain-specific content searching and search results ranking for problem determination and resolution for complex systems.

### TECHNICAL FIELD

Embodiments of the invention relate generally to automated systems and methods for search-based problem determination and resolution for complex systems and, in particular, automated search-based problem determination and resolution systems in which domain-specific data models for a class of complex systems, which are representative of structural relationships of entities within the class of complex systems, are utilized to provide enhanced domain-specific content searching and search results ranking for problem determination and resolution for complex systems.

### BACKGROUND

One of the most challenging aspects in complex system management involves implementation of automated problem determination and resolution tools that can effectively help identify performance problems and identify root causes of such performance problems in complex systems such as hardware and/or software systems. For example, in complex software systems, automated problem determination and resolution tools are used to assist in the process of resolving software defects, bugs, reported issues, unexpected application behavior, etc.

In general, conventional techniques for automated problem determination and resolution include (i) decision tree-based systems, (ii) rules-based systems, (iii) case-based systems and (iv) search-based systems. With such conventional methods, decision tree based systems, rules based systems and case-based systems have complex frameworks that require special-purpose systems specifically adapted to prepare certain content and require considerable maintenance of such content. On the other hand, search-based systems are less complex, generally requiring only access to relevant documentation, a crawler and/or content management facility, an indexer and a search engine.

For example, commercially available search engines, such as Google, can be used to search for relevant content over the Internet to rediscover related documents for purposes of problem resolution in a given domain of interest. Although the Internet and other information networks can provide a vast source of electronically accessible information from which relevant information for problem determination and resolution can be extracted, it can be problematic to implement search-based methods that allow an individual to efficiently locate desired information and extract relevant information of interest for a given problem at hand.

For example, conventional search-based methods for problem determination and resolution based on “keyword” searching can be inefficient and inaccurate for various reasons. In particular, when a user formulates a search query (Boolean, natural language search, etc.) the user query will include search terms that the user believes are pertinent to the issue at hand for troubleshooting or researching a given complex system or product. If the search query contains terms with broad scope, the keyword searches can return a large number of documents (based on keywords appearing in the documents) which may or may not be relevant to the specific problem at hand. Moreover, if the user query contains terms that are not commonly used to describe the products or otherwise describe troubleshooting techniques for the issue at hand, the keyword search may not be effective in accessing relevant documents or information and, consequently, it can be difficult and time consuming for a user to locate relevant problem determination and resolution information.

### SUMMARY OF THE INVENTION

Embodiments of the invention generally include automated systems and methods for search-based problem determination and resolution for complex systems in which domain-specific data models for a class of complex systems, which are representative of structural relationships of entities within the class of complex systems, are utilized to provide enhanced domain-specific content searching and search results ranking for problem determination and resolution for complex systems.

In one exemplary embodiment of the invention, an automated method for providing search-based problem determination and resolution for complex systems includes:

receiving a user-formulated search query from a user seeking access to troubleshooting information for a target computing platform;

obtaining a domain-specific data model for a class of computing platforms associated with the target computing platform, wherein the domain-specific data model comprises a hierarchical structure of related concepts, which represents structural relationships of entities within the class of computing platforms;

automatically generating one or more additional search queries that include concept terms in the data model which are related to terms of the user formulated search query;

performing a search using the user-formulated search query and each additional search query and returning a ranked list of links of search results for each search;

automatically merging the search results for each search into a list of re-ranked search results for presentation to the user.

These and other embodiments, aspects, features and advantages of the present invention will be described or become apparent from the following detailed description of preferred embodiments, which is to be read in connection with the accompanying drawings.

### BRIEF DESCRIPTION OF THE DRAWINGS

FIG. 1 schematically illustrates an automated search-based problem determination and resolution system according to an exemplary embodiment of the invention.

FIG. 2 is a flow diagram of an automated search-based problem determination and resolution system process according to an exemplary embodiment of the invention.

FIGS. 3A and 3B are exemplary domain-specific hierarchical taxonomic data structures representative of complex hardware systems, which may be implemented for search-based problem determination and resolution according to an exemplary embodiment of the invention.

### DETAILED DESCRIPTION OF EXEMPLARY EMBODIMENTS

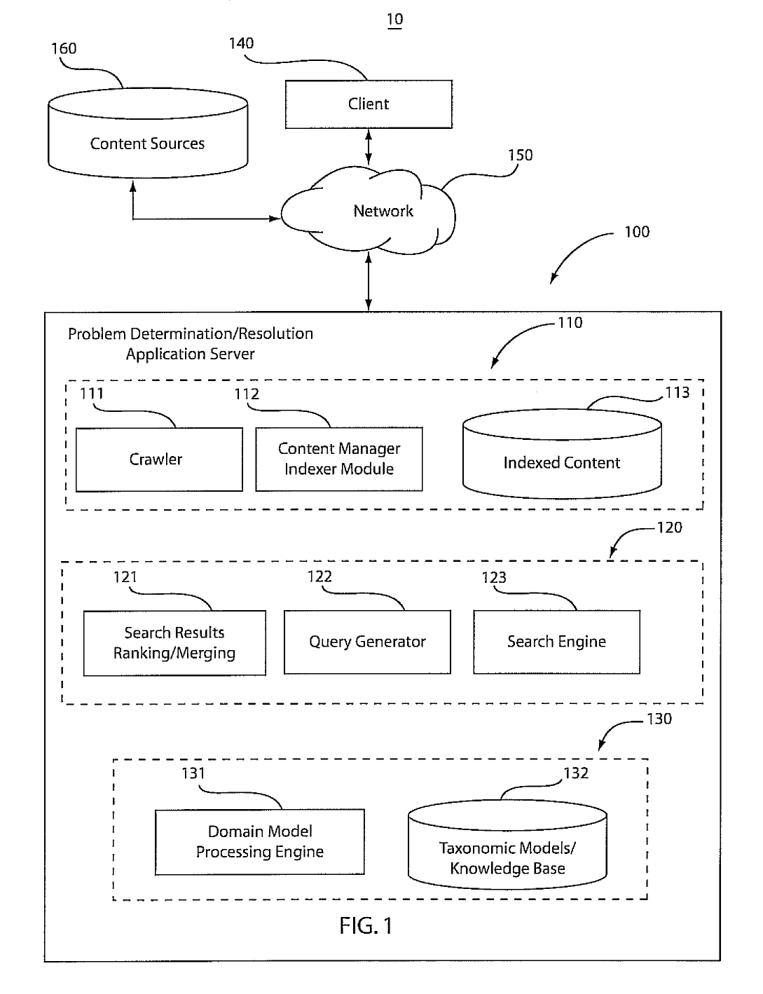

Exemplary embodiments of automated search-based problem determination and resolution systems and methods in which domain-specific data models for a class of complex systems, which are representative of structural relationships of entities within the class of complex systems, are utilized to provide enhanced domain-specific content searching and search results ranking for problem determination and resolution for complex systems, will now be described in further detail with reference to the FIGS. 1, 2 and 3A/3B. It is to be understood that the systems and methods described herein in accordance with the present invention may be implemented in various forms of hardware, software, firmware, special purpose processors, or a combination thereof. Preferably, the present invention is implemented in software as an application comprising program instructions that are tangibly embodied on one or more program storage devices (e.g., hard disk, magnetic floppy disk, RAM, CD ROM, DVD, ROM and flash memory), and executable by any device or machine comprising suitable architecture. It is to be further understood that because the constituent system modules and method steps depicted in the accompanying Figures can be implemented in software, the actual connections between the system components (or the flow of the process steps) may differ depending upon the manner in which the application is programmed. Given the teachings herein, one of ordinary skill in the related art will be able to contemplate these and similar implementations or configurations of the present invention.

FIG. 1 schematically illustrates a search-based problem determination and resolution system according to an exemplary embodiment of the invention. More specifically, FIG. 1 illustrates a computing system (10) comprising an automated search-based problem determination and resolution system (100) which processes user requests received from client device (140) over a communications network (150). The requests include queries from users seeking information or troubleshooting a problem in a complex computing platform such as a hardware or software platform. The system (100) comprises various modules that provide a platform to support automated search-based problem determination and resolution services in which one or more domain-specific data models, such as taxonomic models, representative of structural/configuration characteristics of entities within a class of computing platforms are employed to provide improved domain-specific content searching and search results ranking for problem determination and resolution.

FIG. 1 depicts a client/server-based computing system in which the system (100) may be a network application that executes on one or more server nodes over the network (150) (e.g., LAN (local area network), WAN (wide-area network), WLAN (wireless LAN), corporate Intranet, the Internet, etc.), where the system (100) is accessible through a browser-based GUI interface of the client device (140). The client device (140) may be any type of device such as computer workstation with a graphical user interface or other suitable computing device such as PDA (personal digital assistant), mobile cell phone, standard telephone, etc., capable of communicating with the application server (100) over the communications network (150). In other embodiments, the automated search-based problem determination and resolution system (100) may be implemented as a stand alone application that resides and executes on a client device.

In general, the search-based problem determination and resolution system (100) comprises a search engine module (110), a query generator module (120) and a domain knowledge management module (130). The search engine module (110) may be any standard or generic search engine that comprises a crawler program (111), content manager/indexer module (112) and a catalog or database of indexed content (113). As is known in the art, the crawler (111) is a program that can visit web sites and read pages and other information in order to create entries for a search engine index. The content manager (113) is program that creates an content index (113) from pages and information read by the crawler (111). The search engine (110) can be utilized to locate and access content from various content sources (160) at remote locations over a communications network (150) to mine and index relevant problem resolution information for one or more domain-specific applications.

The query processor module (120) comprises a search results merging/ranking module (121), a query generator (122) and a search engine (123). The domain knowledge manager module (130) comprises a domain model processing engine (131) and a database (132) of domain-specific knowledge associated with one or more types of complex systems for which the system (100) is configured to provide technical support and customer assistance in problem determination. The database (132) stores domain specific knowledge regarding one or more complex computing systems according to an ontological model that defines a collection of domain-specific concepts and describes relationships that exist for and between the concepts. In particular, the database (132) persistently stores one or more domain-specific data models for one or more classes of computing platforms, wherein each data model comprises a hierarchical structure of related concepts (e.g., taxonomy) that represents structural relationships of entities within the associated class of computing platforms.

The data models which comprise domain information knowledge in database (132) are managed by and accessed through the domain model processing engine (131). The domain-specific data models representative of complex systems are utilized by the query processor module (120) to provide enhanced domain-specific content searching and search results ranking to thereby obtain and present most relevant user query-related information for problem determination and resolution for a complex system and, thus, rediscover information related to problem determination and resolution in the complex system. In particular, the query generator (122) receives and processes a user-formulated search query from a user seeking access to troubleshooting information for a target computing platform. The query generator (122) accesses a stored domain-specific data model corresponding to the target computing platform and automatically generates one or more additional search queries that include concept terms in the data model which are related to terms of the user formulated search query.

The user-formulated search query and each additional search query are applied to the search engine module (123) which searches the indexed content (113) or remote content sources (160) to find documents and information based on the applied search queries. The returned search results are processed by the search results ranking/merging module (121) to generated a ranked list of links of search results for each search and automatically merge the search results for each search into a list of re-ranked search results for presentation to the user.

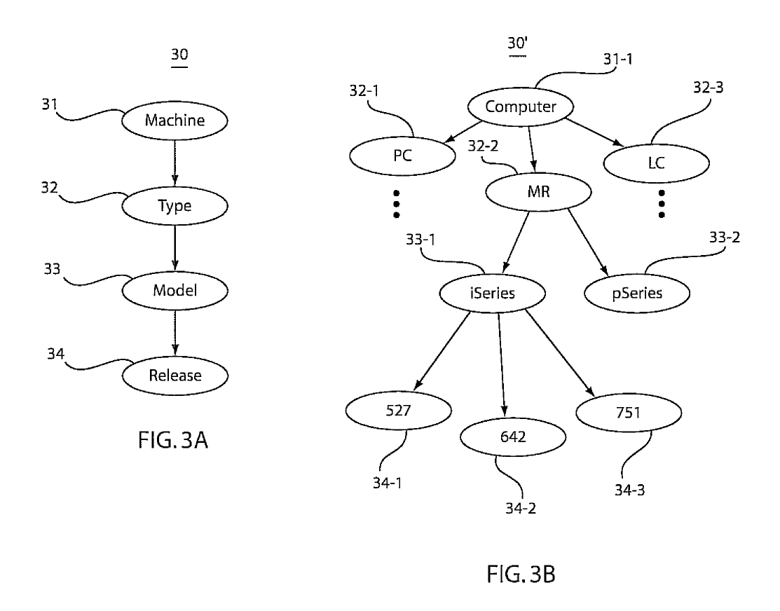

FIGS. 3A and 3B illustrate data models comprising a hierarchical structure of related concepts representative of structural and configuration relationships between entities in a general class of computer machines, according to exemplary embodiments of the invention. In particular, FIG. 3A illustrates a general ontological data model (30) comprising a hierarchy of related concepts that may be utilized for classifying entities within a class of computer machines based on subclasses (concepts) of machine type, model and release.

In the domain data model (30) of FIG. 3A, a root tree level includes a root node (31) that represents a “Machine” class (concept), a first tree level includes a child node (32) that represents a “Type” class, a second tree level includes a child node (33) that represents a “Model” class and a third tree level includes a child node (34) that represent a “Release” class. In FIG. 3A the Machine class (31) can represent a collection of computer hardware platforms for a given manufacture, where the child nodes represent a set of related concepts that may be used to partition domain information for the Machine class into broad, coarse semantic categories in which entities can be classified based on similarities and differences in structural and configuration features and characteristics at different granularity levels, for example. For instance, the root class of “Machine” can be partitioned into different “Types” of the machine within the class “Type”, Each Type subclass can be partitioned into different “Model” subclasses, and each “Model” subclass can be partitioned into different “Release” subclasses.

FIG. 3B illustrates is an example hierarchical structure of semantic components for a domain-specific class of machines, i.e., computer hardware platforms of a given manufacture, which is based on the information model (30) of FIG. 3A. In FIG. 3B, a root node (31_1) labeled “computer” represents a broad class of computer hardware platforms over various computer systems manufactured by a given manufacture. A first tree level (32) includes a plurality of child nodes (32_1, 32_2, and 32_3) that partitions the Computer class (31_1) into different “Types” of computer hardware platforms within the root class computer (31_1) For instance, the child nodes (32_1), (32_2) and (32_3) are labeled with broad semantic concepts for different types of computers, including personal computers (PC), midrange computer systems (MR) (e.g., application servers), large size computer systems (LC) (e.g., mainframes), respectively, which allows partitioning of different types of machines based on similar and dissimilar structural and configuration characteristics on a coarse level. Machines with different hardware platform Types are structurally different and are dynamically configured at boot time different. In this regard, the child nodes (32) are labeled with broad, coarse semantic categories that broadly describe different types of computer hardware platforms having basic distinguishing structural frameworks at a coarse granularity level.

Moreover, each Type class is partitioned based on different Model classes. For example, as shown in FIG. 3B, the MR class (32_2) is further partitioned into distinct Model classes, including an “iseries” class (33_1) and “pseries” class (33_2), which is representative of different models of servers manufactured by International Business Machines Corporation. Moreover, each Model class is partitioned based on different Release classes. For example, as shown in FIG. 3B, the iseries model class (33_1) is further partitioned into a plurality of release subclasses (34_1), (34_2) and (34_3), which are representative of different releases of models of servers manufactured by International Business Machines Corporation. In general, different model classes and release classes provide more fine level classification of computer hardware platforms based on fundamental structural and configuration characteristics, such as the number of processors or I/O bus structure, operating systems, for example.

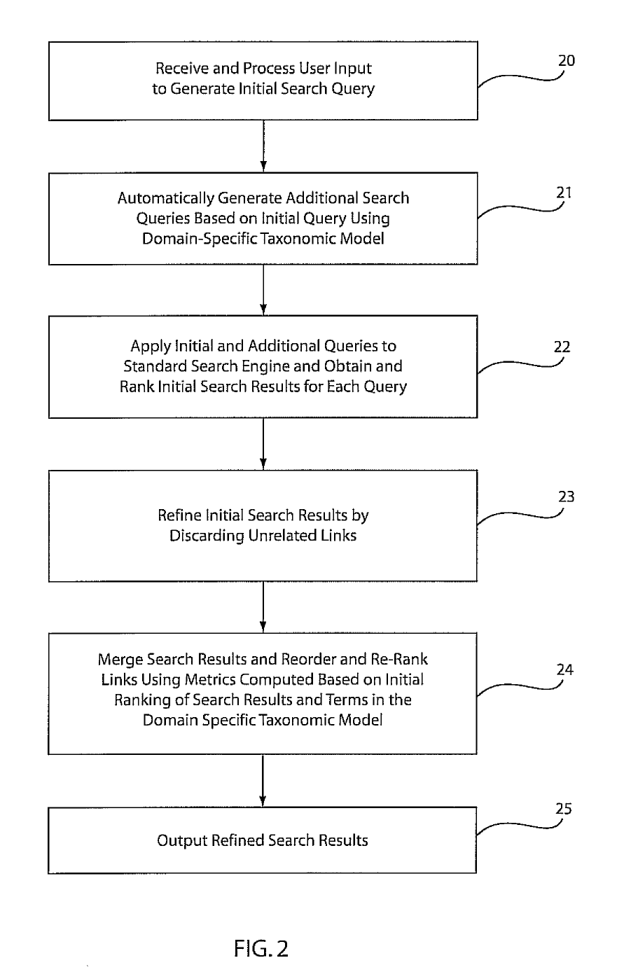

FIG. 2 is a high-level flow diagram illustrating a method an automated search-based problem determination and resolution system according to an exemplary embodiment of the invention. For illustrative purposes, the exemplary embodiment of FIG. 2 will be described with reference to the search-based problem determination and resolution system (100) of FIG. 1 and the taxonomic model of FIG. 3B, wherein it is assumed that the system (100) supports a search-based problem determination and resolution in the domain of complex computer hardware platforms. The method of FIG. 2 assumes that a user session is established with the system (100) and the system (100) receives a user-formulated search request that includes search terms that a user believes are pertinent to troubleshooting a particular problem for a complex computer system. The user-formulated search request received by the system (100) is parsed and processed by the query generator (122) to formulate an initial search query based on the user-formulated search terms (step 20).

Moreover, the query generator (122) automatically generates one or more additional queries that expands the initial user-formulated query using the relevant domain-specific data model (step 21). For example, the user-formulated query is processed using a relevant domain-specific data model for the given problem domain to automatically generate one or more additional search queries that include concept terms in the data model which are related to terms of the user formulated search query. In one exemplary embodiment described in further detail below, the process of automatically generating one or more additional search queries comprises computing a distance metric over paths in the data model, which indicates a distance between terms of the user-formulate query and concept terms along paths in the data model, and using the distance metric to select concept terms within a specified distance (relationship) to terms of the user formulated query. This process significantly increases the likelihood that the additional related terms will be helpful to the search refinement process, identifying a plurality of refined search queries, each of which comprises all terms of the query submitted by the user and an additional term. An exemplary method for generating additional search queries using metric computed according to Equations (1) and (2) below will be discussed in further detail.

The user-submitted and additional search queries are then applied to the standard search engine and the search results for each query are obtained and ranked (step 22). In this process, the search results for the user-formulated search query and each additional search query are separately ranked and ordered to generated a ranked list of links of search results for each search. In general, the search results for each query may be ranked using standard techniques wherein during a search, the search results (links) obtained for each query submitted to the search engine will be processed and ranked according to a similarity/relevance measure between the query terms and a words/phrased contained in a corresponding document. The initial search results for each query may be refined at this point by discarding any unrelated links (step 23). For example, this initial refinement process may involve removing links to any documents that do not contain related terms.

Next, the search results are automatically merged into a single list of re-ranked search results (step 24) and the merged result list is presented to the user (step 25). In one exemplary embodiment, the ranked list of search results that are returned (in step 22) are merged by re-ranking and reordering the search results using metric computed based on the initial rankings of the search results and terms in the relevant data model used to refine the search queries. In particular, in one exemplary embodiment of the invention, the process of automatically merging the search results for each search into a list of re-ranked search results for presentation to the user includes a process in which for each separate ranked list of links of search results, a weighted rank metric is determined for each link in that ranked list of links based on the ranking of the links and the distance metric d between the search terms for the associated path, and the links of all search results are reordered into an ordered list based on the weighted rank metric for the links. Moreover, the process may include resolving rating collisions between links having the same weighted rank, and recomputing the rank of links in the ordered list based on resolution of rating collisions. An exemplary method for re-ranking and merging the search results using metric computed according to Equations (2)-(6) below will be discussed in further detail below.

In one exemplary embodiment of the invention, the methods for generating additional search queries and re-ranking and merging the search results of the queries may be performed by computing metrics based on a taxonomic data model, such as depicted in FIG. 3B, based on a plurality of metrics computed using formulas (1)˜(6) as discussed hereafter. For instance, step (21) of FIG. can be performed by computing metrics using the taxonomic model of FIG. 3B based on the user-submitted search query, metrics are determined from the hierarchy in FIG. 3B that describes hardware relationships. All possible connected paths in the hierarchy composed of nodes and edges are considered. If there is a link (relationship) between two terms in a path, the distance d between the two terms is counted as 1. The distance is then extended by induction. The distance d between terms and a path over the hierarchy is a metric denoted as:

d(terms,path) (1)

Next, we consider the set of paths in which the distance d between specified terms is less than a predetermined number, k, which is denoted by:

CPaths(terms,k)={path|d(terms,path)<k} (2)

For each path that is determined to be within the restricted distance k to the terms is used to automatically generate an additional query containing all terms of the path, which is submitted to the search engine along with the user-submitted query. The search results (links) obtained for each query submitted to the search engine will be processed and ranked according to a similarity/relevance measure between a query and a corresponding document. The rank assigned to a link in a specific path is denoted as:

R(L,path) (3)

Once the initial search results are obtained and ranked, a weighted link rank (WR) is determined for each link in a given patch based on the rank of the link for the path and the distance between search terms. For example, a weighted link rank can be determined by:

WR(L,path)=R(L,path)(d(terms,path)+1) (4)

Next, possible rating collisions are resolved by reordering links with the same WR in a manner that takes into account the distance of terms in the path and the Weighted Rank of the link. This process is referred to as a Weighted Rank Collision Resolved (WRCR) process, wherein the process may be performed by determining:

WRCR(L)=MIN path(WR(L,path) order by d(terms,path),R(L,path) (5)

Next, the link rank is recomputed according to the WRCR. In one exemplary embodiment, link ranks are re-ranked as follows:

RR(L)=#{L1|WRCR(L1)<WRCR(L)} (6)

The exemplary methods described above will now be illustrated by way of example with reference to FIG. 3B wherein it is assumed that a user submitted query is “i527 crash”. Based on the above formulas (1) and (2), the hierarchical model (30′) in FIG. 3 is traversed to determined the set of paths in which the distance d between specified terms is less than a predetermined number, k, where all terms within distance k=3 are identified:

(CPaths(“i527, crash”, 3)).

Assume the identified paths include terms as follows: (i527 crash), (iSeries crash), (i527 iSeries crash), (i642 iSeries crash), (i642 crash), etc, which includes paths with 3 distance of the terms. Each path generates a query to the generic search engine.

Next, we assume that the returned results for the search queries are as follows:
(1) Query (i527crash) returns and ranked list of results (L1,1; L2,1; L3,1; etc.)
(2) Query (i527 iSeriescrash) returns a ranked list of results (L1,2; L2,2; L3,2; etc.)
(3) Query (iSeriescrash) returns a ranked list of results (L1,3; L2,3; L3,3; etc.)

We can discard unrelated links without taxonomy terms.

Next, using formula (4), a Weighted Rank (WR) is computed based on the rate of the link for the path and the distance between search terms. In the example, this computation results in:

1. WR(L1,1)=1; WR(L2,1)=2; WR(L3,1)=3

2. WR(L1,2)=2; WR(L2,2)=4; WR(L3,2)=6

3. WR(L1,3)=3; WR(L2,2)=6; WR(L3,3)=9 etc.

Next, using formula (5), the Weighted Rank Collision Resolved (WRCR)) is computed as:

### WRCR(L1,1)=1; WRCR(L2,1)=2; WRCR(L1,2)=2; WRCR(L3,1)=3; WRCR(L1,3)=3;

Next, using formula (6), the link ranks are re-ranked according to the WRCR as follows:

### RR(L1,1)=1; RR(L2,1)=2; RR(L1,2)=3; RR(L3,1)=4; RR(L1,3)=5; etc.

Although illustrative embodiments have been described herein with reference to the accompanying drawings, it is to be understood that the invention is not limited to the precise system and method embodiments described herein, and that various other changes and modifications may be affected therein by one or ordinary skill in the art without departing from the scope or spirit of the invention. All such changes and modifications are intended to be included within the scope of the invention as defined by the appended claims.

What is claimed is:

1. An automated method for providing search-based problem determination and resolution for complex systems, comprising:
receiving a user-formulated search query from a user seeking access to troubleshooting information for a target computing platform;
obtaining a domain-specific data model for a class of computing platforms associated with the target computing platform, wherein the domain-specific data model comprises a hierarchical structure of related concepts, which represents structural relationships of entities within the class of computing platforms;
automatically generating one or more additional search queries that include concept terms in the data model which are related to terms of the user formulated search query;
performing a search using the user-formulated search query and each additional search query and returning a ranked list of links of search results for each search;
automatically merging the search results for each search into a list of re-ranked search results for presentation to the user.

2. The method of claim 1, wherein automatically generating one or more additional search queries comprises computing a distance metric over paths in the data model, which indicates a distance between terms of the user-formulate query and concept terms along paths in the data model

3. The method of claim 2, wherein computing a distance metric comprises traversing paths in the hierarchical structure of concepts to determine a distance, d, between each traversed path and the terms of the user-formulated query, and wherein generating additional queries comprises determining one or more path in which the distance d between the path and the terms of the user-formulated query does not exceed a predefined distance threshold, and generating an additional query that includes concept terms for concepts that are included in that path.

4. The method of claim 2, wherein automatically merging the search results for each search into a list of re-ranked search results for presentation to the user comprises:
for each separate ranked list of links of search results, determining a weighted rank metric for each link in that ranked list of links based on the ranking of the links and the distance metric d between the search terms for the associated path; and
reordering the links of all search results into an ordered list based on the weighted rank metric for the links.

5. The method of claim 4, further comprising:
resolving rating collisions between links having the same weighted rank; and
recomputing the rank of links in the ordered list based on resolution of rating collisions.

6. The method of claim 1, wherein the domain-specific data model represents a structural relationships between entities in a class of computer hardware platforms.

7. The method of claim 6, wherein the hierarchical structure of related concepts comprise concepts associated with a “type” class and a “model” class.

8. The method of claim 1, wherein performing a search comprises applying the user-formulated search query and additional search queries to a standard search engine.

9. The method of claim 1, further comprising discarding any link in search results for a given search which does not contain a concept term.

10. A program storage device readable by a computer, tangibly embodying a program of instructions executable by the computer to perform methods steps for providing search-based problem determination and resolution for complex systems, comprising:
receiving a user-formulated search query from a user seeking access to troubleshooting information for a target computing platform;
obtaining a domain-specific data model for a class of computing platforms associated with the target computing platform, wherein the domain-specific data model comprises a hierarchical structure of related concepts, which represents structural relationships of entities within the class of computing platforms;
automatically generating one or more additional search queries that include concept terms in the data model which are related to terms of the user formulated search query;
performing a search using the user-formulated search query and each additional search query and returning a ranked list of links of search results for each search;
automatically merging the search results for each search into a list of re-ranked search results for presentation to the user.

11. The program storage device of claim 10, wherein instructions for automatically generating one or more additional search queries comprise instruction for computing a distance metric over paths in the data model, which indicates a distance between terms of the user-formulate query and concept terms along paths in the data model

12. The program storage device of claim 11, wherein the instructions for computing a distance metric comprise instructions for traversing paths in the hierarchical structure of concepts to determine a distance, d, between each traversed path and the terms of the user-formulated query, and wherein generating additional queries comprises determining one or more path in which the distance d between the path and the terms of the user-formulated query does not exceed a predefined distance threshold, and generating an additional query that includes concept terms for concepts that are included in that path.

13. The program storage device of claim 11, wherein the instructions for automatically merging the search results for each search into a list of re-ranked search results for presentation to the user comprise instructions for:
for each separate ranked list of links of search results, determining a weighted rank metric for each link in that ranked list of links based on the ranking of the links and the distance metric d between the search terms for the associated path; and
reordering the links of all search results into an ordered list based on the weighted rank metric for the links.

14. The program storage device of claim 13, further comprising instructions for:
resolving rating collisions between links having the same weighted rank; and
recomputing the rank of links in the ordered list based on resolution of rating collisions.

15. The program storage device of claim 10, wherein the domain-specific data model represents a structural relationships between entities in a class of computer hardware platforms.

16. The program storage device of claim 15, wherein the hierarchical structure of related concepts comprise concepts associated with a “type” class and a “model” class.

17. The program storage device of claim 10, wherein the instructions for performing a search comprise instructions for applying the user-formulated search query and additional search queries to a standard search engine.

18. The program storage device of claim 10, further comprising instructions for discarding any link in search results for a given search which does not contain a concept term.

19. A computing system, comprising:
a search engine;
a storage device that persistently stores one or more domain-specific data models for one or more classes of computing platforms, wherein each data model comprises a hierarchical structure of related concepts that represents structural relationships of entities within the associated class of computing platforms; and
a query server system that (i) receives a user-formulated search query from a user seeking access to troubleshooting information for a target computing platform, (ii) accesses a stored domain-specific data model corresponding to the target computing platform, (iii) automatically generates one or more additional search queries that include concept terms in the data model which are related to terms of the user formulated search query, (iv) applies the user-formulated search query and each additional search query to the search engine, and (v) processes a ranked list of links of search results for each search to automatically merge the search results for each search into a list of re-ranked search results for presentation to the user.
